(19) United States
(12) Patent Application Publication
(10) Pub. No.: US 2010/0079788 A1
(43) Pub. Date: Apr. 1, 2010

(54) VARIABLE DATA PRINTING METHOD UTILIZING MULTIPLE PRINTERS

(75) Inventor: Tetsuhiro KODERA, Irvine, CA (US)

Correspondence Address: YING CHEN;Chen Yoshimura LLP, 255 S. GRAND AVE., # 215, LOS ANGELES, CA, 90012, US

(73) Assignee: KONICA MINOLTA SYSTEMS LABORATORY, INC., Huntington Beach, CA (US)

(21) Appl. No.: 12/239,078

(22) Filed: Sep. 26, 2008

(51) Int. Cl. G06F 3/12

(52) U.S. Cl. 358/1.15

(57) ABSTRACT

A variable data printing (VDP) method is disclosed. The method takes advantage of the capacity of a print shop to increase overall throughput of a VDP production. The shop management software running on a server provides the ability for a print shop operator to divide the VDP production and submit it to multiple printers so that each printer prints different pieces of the production. In one method, the operator enters a division rule to divide the VDP production based on the variable data. In another method, the server automatically determines how to divide the VDP production based on performance of the printers and other the volume of the VDP production.

### BACKGROUND OF THE INVENTION

1. Field of the Invention

This invention relates to a variable data printing method, and in particular, it relates to a variable data printing method executed by a print shop to maximize throughput.

2. Description of Related Art

Variable data printing (VDP) is a form of printing multiple pieces (often large numbers of pieces) where each piece contains a combination of form content (common to all of the pieces or a large subset of the pieces) and variable content (different for each piece, such as name and address). VDP are widely used to print personalized letters, direct marketing materials, billing statements, etc. Typically, a database or external file is used to provide the information for the variable content. Form content is also provided as external files or a database. For example, the variable data and form data may be provided in a PDF file.

### SUMMARY

The present invention is directed to an improved variable data printing method.

An object of the present invention is to provide a convenient way for the print shop manager to print a VDP production to multiple printers.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a variable data printing method implemented in a print shop management apparatus, which includes: (a) receiving input data including variable data and form data, the variable data including a plurality of entries each having a plurality of attributes, the input data further including association rules specifying an association between the variable data attributes and the form data; (b) generating a plurality of print jobs for the plurality of entries using the variable data and form data and selecting a printer for each print job based on one or more division criteria for dividing the plurality of entries among a plurality of printers managed by the print shop management apparatus, wherein the division criteria specify an association between one or more attributes of the entries and the printers; and (c) submitting each print job to the selected printer. Step (b) may include: (b1) generating a print job for each entry, and (b2) selecting a printer for each print job based on the one or more division criteria.

In another aspect, the present invention provides a computer program product that causes a print shop management apparatus to perform the above method.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a schematic diagram illustrating a print shop system in which embodiments of the present invention are implemented.

FIG. 2 illustrates a variable data printing method according to an embodiment of the present invention.

FIG. 3 illustrates a variable data printing method according to another embodiment of the present invention.

### DETAILED DESCRIPTION OF PREFERRED EMBODIMENTS

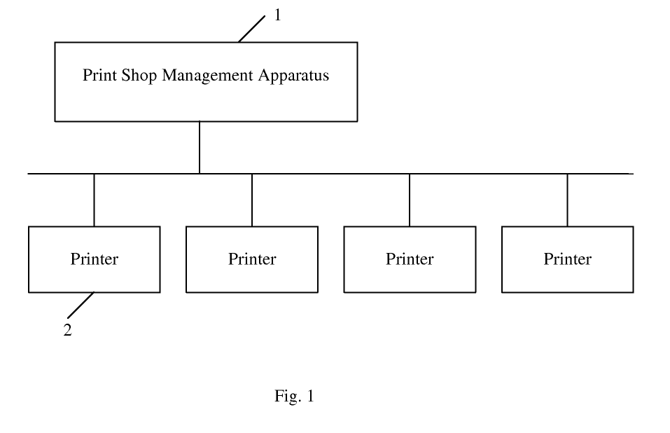

Variable data printing (VDP) is often performed at professional print shops or in-house print/copy departments, where multiple printers are employed to processes large numbers of print jobs. Such an environment is collectively referred to as a “print shop” in this disclosure. As schematically shown in FIG. 1, a print shop typically includes a print shop management apparatus 1 (e.g. a server computer) and a plurality of printers 2 connected to each other by a data communication line or network such as an LAN (Local Area Network). The print shop often employs other devices such as finishing devices (not shown in FIG. 1), which may be on-line or off-line. The VDP method described herein is implemented by the print shop management system software, which is stored in a storage device (e.g., a hard disk drive) of the server 1 and is executed by the server.

The following descriptions uses a direct marketing campaign as an example, but the method can be used in may other applications. To produce a VDP production, input data is provided that includes variable data and form data. Variable data, which may be provided in the form of a database, includes a plurality of entries each associated with an individual as a target of the marketing campaign. Each entry in the variable data includes a plurality of attributes such as the individual's name and address, demographic information, behavioral history, other specific information, etc. Not all variable data are printed. The form data includes contents to be printed, and may be text, graphics, images, etc. A selected combination of contents will be printed on each piece. The input data also includes a set of association rules that define the associations between variable data attributes and form data. For example, the rules may specify what combination of form data contents is to be printed for each individual based on his age. Such rules are typically pre-defined by the creator of the marketing campaign based on market research and models. When performing VDP printing, the appropriate form data is selected for each entry based on it attributes, and combined with variable data (e.g. the name and address) to generate each printed piece.

In a conventional VDP method, a VDP production is submitted to a single printer and all pieces are printed at the same printer. Embodiments of the present invention provide a VDP method which takes advantage of the capacity of a print shop to increase overall throughput of a VDP production. According to one aspect of the present invention, the print shop management software application provides the ability for a print shop operator to divide the VDP production and submit it to multiple printers so that each printer prints different pieces of the production. As a result, the overall time for the production may be greatly reduced.

In one embodiment, the print shop management software application allows the operator to divide the VDP production based on the variable data. For example, if the association rules of the VDP specify that different images are to be printed based on the age group of the individual target, the operator may divide the VDP production such that all pieces for individuals in a first age group is printed on a first printer, all pieces for individuals in a second age group is printed on a second printer, etc. An advantage of dividing the VDP production this way is that each printer will print the same image, which simplifies image processing performed by each printer. The printer may also store the form data in its memory, so that the server does not need to transfer the same data to the printer multiple times. Another advantage of dividing the production based on the association rules is that the output can be better organized.

A graphical user interface (GUI) may be implemented to allow the operator to specify how the production is to be divided. The GUI may display the pre-defined association rules so that the operator can make the decision more easily and intelligently.

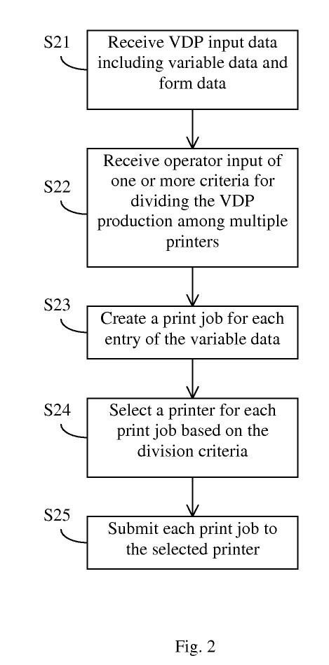

FIG. 2 illustrates a process of dividing a VDP production to multiple printers according to a first embodiment of the present invention. First, when a VDP production request is received, the input data, including variable data and form data, is loaded into the server (step S21). The operator enters one or more criteria for dividing the production among multiple printers (step S22). To aid the operator's decision, the server may display the pre-defined association rules so the operator is informed of how the variable data is associated with the form data. For example, from the displayed associate rules, the operator sees that different images are to be printed based on the individual's age group, and that three different age groups are defined. Based on this information, the operator may specify three printers for printing the entries for the three age groups respectively.

The server creates a print job for each entry in the variable data (i.e. each individual target) (step S23). Each print job includes a job ticket and one or more source files. A job ticket is a file or a database entry that contains a set of print job parameters, such as basic settings (number of copies, orientation of paper, collate, offset printing, original paper size, output paper size, paper type, paper source, etc.), layout settings, cover sheet, finishing settings, inter-sheet settings, tab-paper settings, image quality settings, etc. Job tickets are conventionally used in print shop systems to organize print jobs. For each print job, the server selects a printer based on the division criteria for the production (step S24) and submits each print job to the selected printer (step S25).

In conventional printing methods, the server submits a job to a printer by transmitting print data and the job ticket to the printer. The print data may be, for example, PDL (page description language) data generated by the server based on the source files, PDF data if the printer can handle PDF direct printing, etc. Step S25 describe above may be implemented in two ways. In the first implementation, for each print job, the server transmits all print data for the print job to the printer. However, in VDP, certain form data is common to all or a subset of all print jobs submitted to each printer. Thus, in the second implementation, the server transmits print data representing relevant form data (e.g. PDL data representing an image that is printed on all jobs submitted to a particular printer) to each printer only once. The print data is stored on the printer. The print data for each print job refers to certain previously stored print data. Print data generated from the variable data for each job, such as name and address, is transmitted to the printer separately for each print job.

In steps S24 and S25, the server may process the entries of the variable data in the database one by one, select a printer and submit the print job one at a time. Alternatively, the server selects a printer for each print job, then sorts all of the print jobs based on the printer selection before submitting them to the printers. Thus, all entries for one printer are gathered and transferred at once to that printer, where the form data that is common to all such entries is transferred only once.

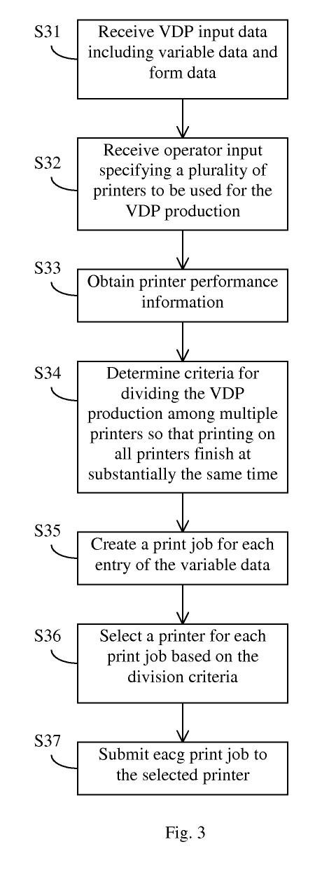

FIG. 3 illustrates a process of dividing a VDP production to multiple printers according to a second embodiment of the present invention. In this embodiment, the server automatically determines how the VDP production will be divided among multiple printers so that printing on all printers will finish at substantially the same time. This makes it convenient for the operator to manage the printing, so the operator may pick up the printouts from the multiple printers at the same time and send them for post-printing processing. As shown in FIG. 3, first, when a VDP production request is received, the input data, including variable data and form data, is loaded into the server (step S31). The operator enters a list of multiple printers to be used for the production (step S32). Alternatively, instead of the operator entering a list of printers, the server may consider all available printers in the print shop that are capable of handling the print job. To obtain a list of all such available and capable printers, the server examines the requirements of the VDP production (e.g., paper size, color or black and white, etc.) and compares them to the capabilities of all printers.

The server obtains information regarding the printing performance (e.g. speed) of each printer (step S33). This may be done by querying the printers for their performance information, or by accessing a previously established database that stores the performance information of the printers. Then, based on the VDP production volume and the variable information, the server automatically determines how the production is to be divided amount the multiple printers so that the printing on all printers will finish at substantially the same time (step S34). Preferably, to the extent possible, the server groups the entries with the same form content and prints them on the same printer.

For example, assume that the operator specifies three printers for use in the production, and the server determines that two of the three printers are high performance printers capable of printing 250 pages per minute and one printer is a low performance printer capable of printing 40 pages per minute. Assume also that the association rules define three different age groups and specify that three images are to be printed for individuals within the three age groups. The server examines the variable information in the database and determines that these three age groups contain approximately 2000, 3000 and 1500 entries. Under these circumstances, the server will print all entries of first age group and 1000 entries of the third age group on the first printer, print all entries of the second age group on the second printer, and print 500 entries of the third age group on the third printer.

The server creates a print job for each entry in the variable data (step S35). For each print job, the server selects a printer based on the division criteria determined in step S34 (step S36), and submits each print job to the selected printer (step S37).

In steps S36 and S37, the server may process the entries of the variable data in the database one by one, select a printer and submit the print job one at a time. Alternatively, the server selects a printer for each print job, then sorts all of the print jobs based on the printer selection before submitting them to the printers. Thus, all entries for one printer are gathered and transferred at once to that printer, where the form data that is common to all such entries is transferred only once.

Although in the above examples a single print job is generated for each entry and submitted to a selected printer, other implementations are possible. For instance, a single print job may be generated for a single age group, which may includes a plurality of entries of the age group, and each print job is then forwarded to a single printer. In this alternative implementation, three print jobs for three age groups are respectively generated in the abovementioned examples.

It will be apparent to those skilled in the art that various modification and variations can be made in the variable data printing method and related apparatus of the present invention without departing from the spirit or scope of the invention. Thus, it is intended that the present invention cover modifications and variations that come within the scope of the appended claims and their equivalents.

What is claimed is:

1. A variable data printing method implemented in a print shop management apparatus, the method comprising:
(a) receiving input data including variable data and form data, the variable data including a plurality of entries each having a plurality of attributes, the input data further including association rules specifying an association between the variable data attributes and the form data;
(b) generating a plurality of print jobs for the plurality of entries using the variable data and form data and selecting a printer for each print job based on one or more division criteria for dividing the plurality of entries among a plurality of printers managed by the print shop management apparatus, wherein the division criteria specify an association between one or more attributes of the entries and the printers; and
(c) submitting each print job to the selected printer.

2. The method of claim 1, further comprising, prior to step (b), receiving an operator input specifying the division criteria.

3. The method of claim 1, further comprising, prior to step (b), determining the division criteria based on information regarding printing performance of the plurality of printers.

4. The method of claim 3, wherein the division criteria are determined such that the plurality of printers will finish the print jobs substantially simultaneously.

5. The method of claim 1, wherein step (b) comprises:
(b1) generating a print job for each entry, and
(b2) selecting a printer for each print job based on the one or more division criteria.

6. The method of claim 5, wherein step (c) comprises sorting the print jobs according to the selected printers, and submitting a plurality of print jobs to each printer at once.

7. A computer program product comprising a computer usable medium having a computer readable program code embedded therein for controlling a print shop management apparatus, the computer readable program code configured to cause the print shop management apparatus to execute a variable data printing process comprising:
(a) receiving input data including variable data and form data, the variable data including a plurality of entries each having a plurality of attributes, the input data further including association rules specifying an association between the variable data attributes and the form data;
(b) generating a plurality of print jobs for the plurality of entries using the variable data and form data and selecting a printer for each print job based on one or more division criteria for dividing the plurality of entries among a plurality of printers managed by the print shop management apparatus, wherein the division criteria specify an association between one or more attributes of the entries and the printers; and
(c) submitting each print job to the selected printer.

8. The computer program product of claim 7, wherein the process further comprises, prior to step (b), receiving an operator input specifying the division criteria.

9. The computer program product of claim 7, wherein the process further comprises, prior to step (b), determining the division criteria based on information regarding printing performance of the plurality of printers.

10. The computer program product of claim 9, wherein the division criteria are determined such that the plurality of printers will finish the print jobs substantially simultaneously.

11. The computer program product of claim 9, wherein step (b) comprises:
(b1) generating a print job for each entry, and
(b2) selecting a printer for each print job based on the one or more division criteria.

12. The computer program product of claim 11, wherein step (c) comprises sorting the print jobs according to the selected printers, and submitting a plurality of print jobs to each printer at once.
